(19) United States
(12) Patent Application Publication
(10) Pub. No.: US 2014/0182264 A1
(43) Pub. Date: Jul. 3, 2014

(54) AIRCRAFT ENGINE SYSTEMS AND METHODS FOR OPERATING SAME

(71) Applicants: Robert Harold Weisgerber, Loveland, OH (US); Kurt David Murrow, Liberty Township, OH (US); Michael Jay Epstein, Mason, OH (US); Nicholas Dinsmore, Cincinnati, OH (US); Samuel Jacob Martin, Cincinnati, OH (US); Randy M. Vondrell, Sharonville, OH (US); Christopher Thompson, Cincinnati, OH (US); Craig Gonyou, West Chester, OH (US)

(72) Inventors: Robert Harold Weisgerber, Loveland, OH (US); Kurt David Murrow, Liberty Township, OH (US); Michael Jay Epstein, Mason, OH (US); Nicholas Dinsmore, Cincinnati, OH (US); Samuel Jacob Martin, Cincinnati, OH (US); Randy M. Vondrell, Sharonville, OH (US); Christopher Thompson, Cincinnati, OH (US); Craig Gonyou, West Chester, OH (US)

(73) Assignee: General Electric Company, Schenectady, NY (US)

(21) Appl. No.: 13/876,863

(22) PCT Filed: Sep. 30, 2011
(86) PCT No.: PCT/US11/54412

§ 371 Date: Aug. 28, 2013

Related U.S. Application Data
(60) Provisional application No. 61/498,260, filed on Jun. 17, 2011.
(60) Provisional application No. 61/498,268, filed on Jun. 17, 2011.
(60) Provisional application No. 61/498,283, filed on Jun. 17, 2011.
(60) Provisional application No. 61/388,424, filed on Sep. 30, 2010.
(60) Provisional application No. 61/388,415, filed on Sep. 30, 2010.
(60) Provisional application No. 61/388,432, filed on Sep. 30, 2010.

(51) Int. Cl. F02C 7/22

(52) U.S. Cl. CPC F02C 7/22
USPC 60/39.19

(57) ABSTRACT

A gas turbine propulsion system includes a system which utilizes a cryogenic liquid fuel for a non-combustion function.

### CROSS-REFERENCE TO RELATED APPLICATIONS

This is a national stage application under 35 U.S.C. §371(c) of prior-filed, co-pending PCT patent application serial number PCT/US2011/054412, filed on Sep. 30, 2011, which claims priority to U.S. Provisional Applications Ser. Nos. 61/388,424, 61/388,432, and 61/388,415, filed Sep. 30, 2010, and Serial Nos. 61/498,260, 61/498,283, and 61/498,268, filed Jun. 17, 2011, the disclosures of which are hereby incorporated in their entirety by reference herein.

### BACKGROUND OF THE INVENTION

The technology described herein relates generally to aircraft systems, and more specifically to aircraft engine systems and methods of operating same.

Current approaches to cooling in conventional gas turbine applications use compressed air or conventional liquid fuel. Use of compressor air for cooling may lower efficiency of the engine system, and conventional liquid fuels often have limited capacity for absorbing or transporting heat.

Accordingly, it would be desirable to have more efficient cooling in aviation gas turbine components and systems. It would be desirable to have improved efficiency and lower Specific Fuel Consumption in the engine to lower the operating costs.

### BRIEF DESCRIPTION OF THE INVENTION

In an embodiment of the present invention, a gas turbine propulsion system comprises a system which utilizes a cryogenic liquid fuel for a non-combustion function.

### BRIEF DESCRIPTION OF THE DRAWINGS

The technology described herein may be best understood by reference to the following description taken in conjunction with the accompanying drawing figures in which:

FIG. 1 is an isometric view of an aircraft system having a dual fuel propulsion system according to an embodiment of the present invention;

FIG. 2 is a schematic view of an aircraft engine having an intercooler having a direct heat exchanger according to an embodiment of the present invention;

FIG. 3 is a schematic view of an aircraft engine having an intercooler having an indirect heat exchanger according to an embodiment of the present invention;

FIG. 4 is a schematic view of an aircraft engine having an intercooler having a direct heat exchanger according to an embodiment of the present invention;

FIG. 5 is a schematic view of an aircraft engine having an intercooler having an indirect heat exchanger according to an embodiment of the present invention;

FIG. 6 is a schematic view of an aircraft engine having an intercooler having a direct heat exchanger according to an embodiment of the present invention;

FIG. 7 is a schematic view of an aircraft engine having an intercooler having an indirect heat exchanger according to an embodiment of the present invention;

FIG. 8 is a schematic view of an aircraft engine having an intercooler having a direct heat exchanger according to an embodiment of the present invention;

FIG. 9 is a schematic view of an aircraft engine having an intercooler having an indirect heat exchanger according to an embodiment of the present invention;

FIG. 10 is a schematic view of an aircraft engine having secondary cooling systems heat exchangers shown schematically according to an embodiment of the present invention;

FIG. 11 is a schematic view of an cooling circuit in an aircraft system having secondary cooling systems heat exchangers shown schematically according to an embodiment of the present invention;

FIG. 12 is a schematic view of a secondary cooling systems direct heat exchanger according to an embodiment of the present invention;

FIG. 13 is a schematic view of a secondary cooling systems indirect heat exchanger according to an embodiment of the present invention;

FIG. 14 is a schematic view of a portion of a gas turbine engine showing a schematic view of a secondary cooling systems direct heat exchanger;

FIG. 15 is a schematic view of a portion of a gas turbine engine showing a schematic view of a secondary cooling systems direct heat exchanger according to an embodiment of the present invention;

FIG. 16 is a schematic view of a portion of a gas turbine engine showing a schematic view of a secondary cooling systems indirect heat exchanger according to an embodiment of the present invention;

FIG. 17 is a schematic view of a secondary cooling systems direct heat exchanger for lube oil according to an embodiment of the present invention;

FIG. 18 is a schematic view of a secondary cooling systems indirect heat exchanger for lube oil according to an embodiment of the present invention;

FIG. 19 is a schematic view of a secondary cooling systems direct heat exchanger for lube oil in a geared turbofan according to an embodiment of the present invention;

FIG. 20 is a schematic view of a secondary cooling systems direct heat exchanger for fuel-to-fuel cooling according to an embodiment of the present invention;

FIG. 21 is a schematic view of a dual fuel aircraft engine having a turbine clearance control system shown schematically according to an embodiment of the present invention; and

FIG. 22 is a schematic view of a dual fuel aircraft engine turbine having a turbine clearance control system shown schematically according to an embodiment of the present invention.

### DETAILED DESCRIPTION OF THE INVENTION

Referring to the drawings herein, identical reference numerals denote the same elements throughout the various views.

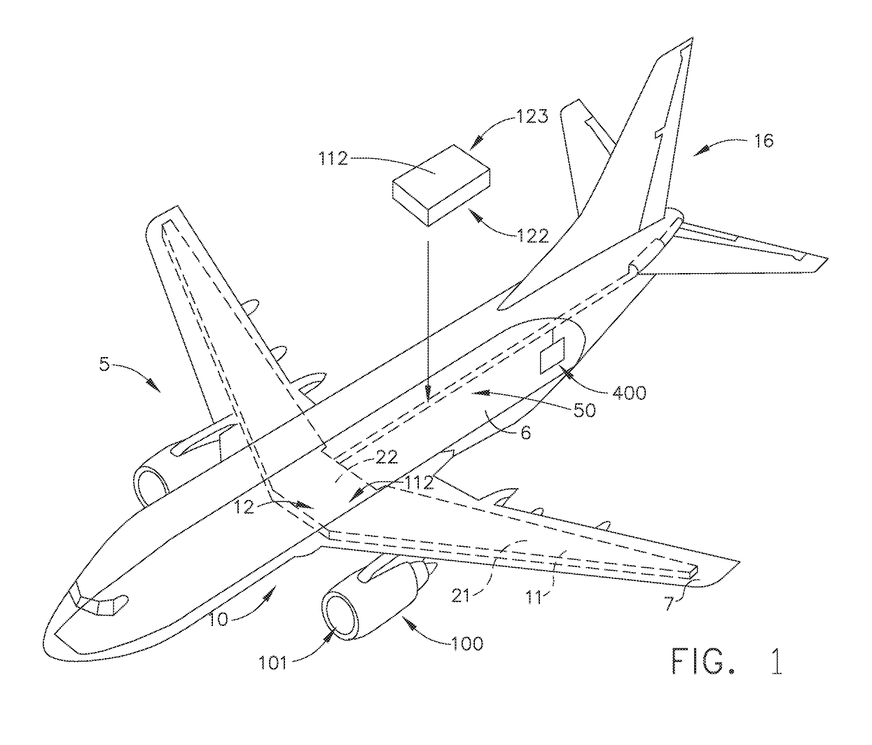

FIG. 1 shows an aircraft system 5 according to an embodiment of the present invention. The aircraft system 5 has a fuselage 6 and wings 7 attached to the fuselage. The aircraft system 5 has a propulsion system 100 that produces the propulsive thrust required to propel the aircraft system in flight. Although the propulsion system 100 is shown attached to the wing 7 in FIG. 1, in other embodiments of the present invention it may be coupled to other parts of the aircraft system 5, such as, the tail portion 16.

The aircraft system 5 has a fuel storage system 10 for storing one or more types of fuels that are used in the propulsion system 100. The aircraft system 5 shown in FIG. 1 uses two types of fuels, as explained further below herein. Accordingly, the aircraft system 5 comprises a first fuel tank 21 capable of storing a first fuel 11 and a second fuel tank 22 capable of storing a second fuel 12. In the aircraft system 5 shown in FIG. 1, at least a portion of the first fuel tank 21 is located in a wing 7 of the aircraft system 5. In an embodiment of the present invention, shown in FIG. 1, the second fuel tank 22 is located in the fuselage 6 of the aircraft system near the location where the wings are coupled to the fuselage. In embodiments of the present invention, the second fuel tank 22 may be located at other suitable locations in the fuselage 6 or the wing 7. In embodiments of the present invention, the aircraft system 5 may comprise an optional third fuel tank 123 capable of storing the second fuel 12. The optional third fuel tank 123 may be located in an aft portion of the fuselage of the aircraft system, such as shown schematically in FIG. 1.

As further described later herein, the propulsion system 100 shown in FIG. 1 is a dual fuel propulsion system that is capable of generating propulsive thrust by using the first fuel 11 or the second fuel 12 or using both first fuel 11 and the second fuel 12. The dual fuel propulsion system 100 comprises a gas turbine engine 101 capable of generating a propulsive thrust selectively using the first fuel 11, or the second fuel 21, or using both the first fuel and the second fuel at selected proportions. The first fuel may be a conventional liquid fuel such as a kerosene based jet fuel such as known in the art as Jet-A, JP-8, or JP-5 or other known types or grades. In embodiments of the present invention, the second fuel 12 is a cryogenic fuel that is stored at very low temperatures. In an embodiment of the present invention, the cryogenic second fuel 12 is Liquefied Natural Gas (alternatively referred to herein as “LNG”). The cryogenic second fuel 12 is stored in the fuel tank at a low temperature. For example, the LNG is stored in the second fuel tank 22 at about −265 Deg. F. at an absolute pressure of about 15 psia. The fuel tanks may be made from known materials such as titanium, Inconel, aluminum or composite materials.

The aircraft system 5 shown in FIG. 1 comprises a fuel delivery system 50 capable of delivering a fuel from the fuel storage system 10 to the propulsion system 100. Known fuel delivery systems may be used for delivering the conventional liquid fuel, such as the first fuel 11. In embodiments of the present invention, and shown in FIG. 1, the fuel delivery system 50 is configured to deliver a cryogenic liquid fuel, such as, for example, LNG, to the propulsion system 100 through conduits that transport the cryogenic fuel.

The embodiment of the aircraft system 5 shown in FIG. 1 further includes a fuel cell system 400, comprising a fuel cell capable of producing electrical power using at least one of the first fuel 11 or the second fuel 12. The fuel delivery system 50 is capable of delivering a fuel from the fuel storage system 10 to the fuel cell system 400. In an embodiment of the present invention, the fuel cell system 400 generates power using a portion of a cryogenic fuel 12 used by a dual fuel propulsion system 100.

Aircraft systems such as the aircraft system 5 described above and illustrated in FIG. 1, as well as methods of operating same, are described in greater detail in commonly-assigned, co-pending U.S. patent application Ser. No. 13/876,750 filed concurrently herewith, entitled “Dual Fuel Aircraft System and Method for Operating Same”, the disclosure of which is hereby incorporated in its entirety by reference herein.

As discussed below, a gas turbine propulsion system can be enhanced through incorporation of a system which utilizes a cryogenic liquid fuel, such as Liquified Natural Gas (LNG), for a non-combustion function such as taking advantage of the significant heat sink capacity of such fuel which is typically maintained at a temperature much lower than other systems, fluids, or structures normally found in the aircraft system environment.

Operation of an aircraft propulsion system can be significantly improved by cooling the air that enters the compressor of the gas turbine engine. Further, a reduction in the compressor exit temperature of the gas turbine engine is desirable for various reasons, such as for example, longer life for the compressor structural materials. A cooled compressor inlet air allows for more heat addition in the combustor either through increasing the overall pressure ratio of the compressor and/or through the addition of more fuel in the combustion process. Further, a cooled compressor inlet air allows for lower temperature compressor operation compared to the operational temperature limits of the gas turbine structures. The higher pressures and/or increased heat release rates in the combustor can provide increased efficiency and/or higher power within the engine cycle of the gas turbine engine. Embodiments of the dual fuel aircraft propulsion system shown herein use an inter cooler, such as, those described herein in various embodiments. An intercooled aviation gas turbine engine architecture can be optimized using the advantages provided (lower specific fuel consumption or higher power) to reduce engine weight for a given application. Such a reduction in engine weight provides even more benefit in the form of reduced operational costs and increased payload to the end user of aircraft system.

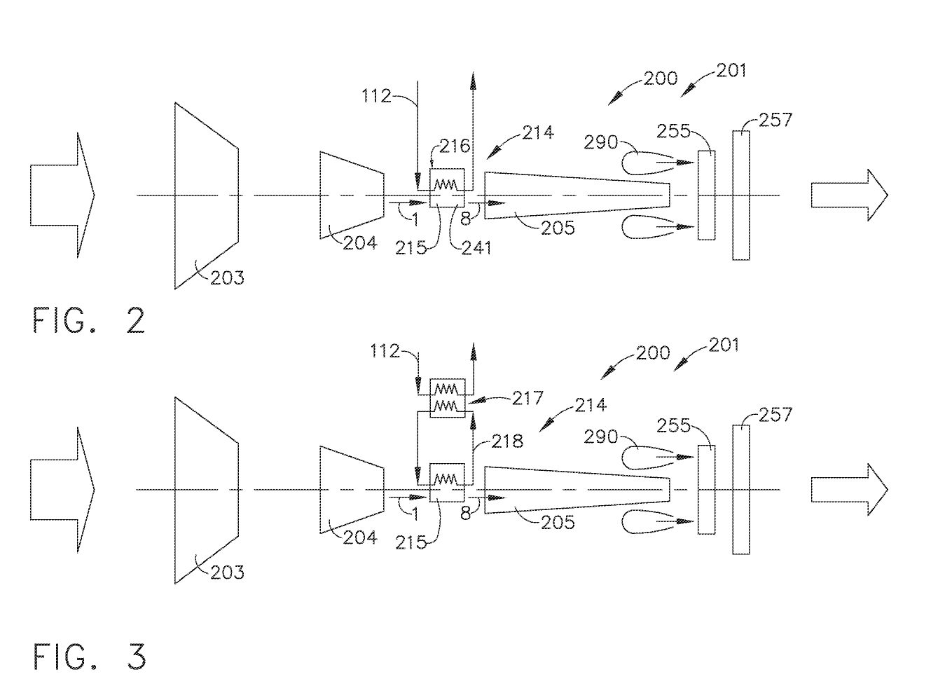

FIGS. 2 to 9 show schematically various embodiments of dual fuel aircraft propulsion systems 200 using dual fuel aircraft gas turbine engines 201. An intercooled gas turbine engine 201 is shown, comprising a compressor 205 driven by a turbine 255, a combustor 290 that generates hot gases that drive the turbine 255 and an intercooler 214. The intercooler 214 (see FIG. 2, for example) comprises a heat exchanger 215 that uses a cryogenic fuel 112 for cooling at least a portion of an airflow 1 that flows into a compressor 205, booster 204, or a fan 203. In an embodiment of the present invention, the cryogenic fuel 112 is Liquefied Natural Gas (LNG). The cooler cryogenic fuel used in the intercooler 214 may be in liquid form or in gaseous form. Heat is transferred from the hotter airflow 1 to the cooler cryogenic fuel and a relatively cooler (compared to airflow 1) airflow 8 enters the compressor (or the booster or fan, in different embodiments as shown in FIGS. 2 to 9).

FIG. 2 shows schematically an embodiment of an intercooled propulsion system 200 having a gas turbine engine 201 comprising an embodiment of an intercooler 214 located axially forward from the compressor 205. The intercooler 214 shown in FIG. 2 comprises a “direct heat exchanger” 216 wherein heat transfer occurs directly through a metallic wall 241 between the cryogenic fuel 112 and at least a portion of the airflow 1. The cryogenic fuel 112 flows through a metallic tube or other suitable passage having the metallic wall 241. Heat exchanger 216 is designed and made using known methods. Known materials can be used in constructing the intercooler 214. The heat exchanger portion of the intercooler 214 may include a shell and tube type heat exchanger, or a double pipe type heat exchanger, or fin-and-plate type heat exchanger. The hot fluid and cold fluid flow in the heat exchanger may be co-current, or counter-current, or a cross current flow type.

FIG. 3 shows schematically an embodiment of an intercooled propulsion system 200 having a gas turbine engine 201 comprising an embodiment of an intercooler 214 located axially forward from the compressor 205. In the intercooler 214 shown in FIG. 3 the intercooler 214 comprises an “indirect heat exchanger” 217 wherein heat transfer occurs between a non-flammable working fluid 218 and at least a portion of the airflow 1, and between the non-flammable working fluid 218 and the cryogenic liquid fuel 112. The non-flammable working fluid 218 (alternatively referred to herein as an “intermediary fluid” or as an “intermediary working fluid” or as a “working fluid”) is cooler than the airflow 1 and therefore removes a portion of the heat from the airflow 1 thereby cooling the airflow 1 in a heat exchanger 215. The cryogenic fuel 112 is cooler than the working fluid 218 and removes a portion of the heat from the working fluid 218. Thus, in an intercooler 214 using the indirect heat exchanger 217, such as for example shown in FIG. 3, the cryogenic fuel 112 cools the airflow 1 indirectly.

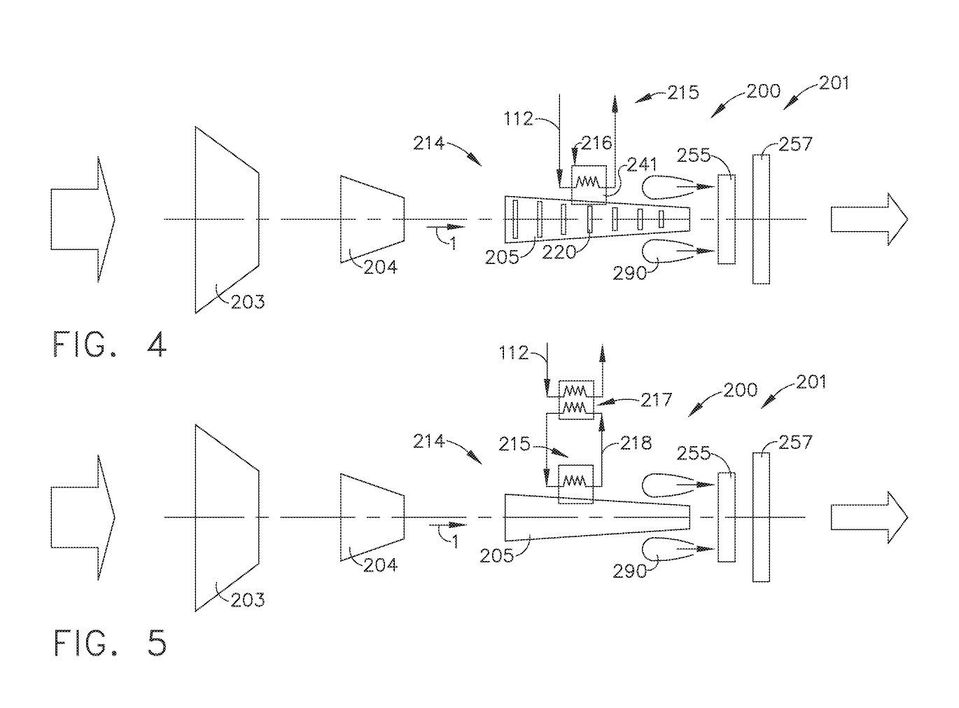

FIG. 4 shows schematically an embodiment of an intercooled propulsion system 200 having a gas turbine engine 201 comprising an embodiment of an intercooler 214 that is located near an intermediate stage 220 of the compressor 205 such that a portion of the airflow 1 through the compressor 205 is cooled. The compressor 205 shown schematically in FIG. 4 has a plurality of intermediate stages 220. The intercooler 214 can be located at any selected location in the compressor near one or more intermediate stages 220 wherein the cooling of air flow provides the most benefits from cooling described above. In an embodiment of the present invention shown schematically in FIG. 4, the intercooler 214 comprises a direct heat exchanger 216 located near an intermediate stage 220 wherein heat transfer occurs directly through a metallic wall 241 between the cryogenic liquid fuel 112 and at least a portion of the airflow 1 through the compressor 205. The direct heat exchanger can be similar to what was described previously herein. In an embodiment of the present invention shown schematically in FIG. 5, the intercooler 214 comprises an indirect heat exchanger 217 that is located near an intermediate stage 220 of the compressor 205. As described previously herein, heat transfer occurs between a non-flammable working fluid 218 and at least a portion of the airflow 1 through the compressor 205, and between the non-flammable working fluid 218 and the cryogenic fuel 112.

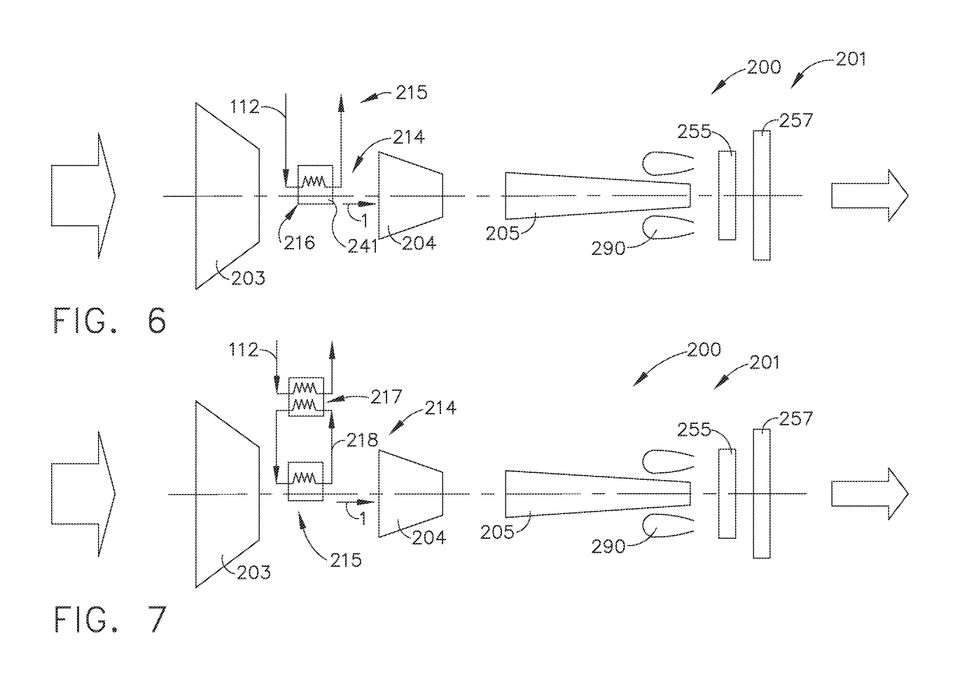

The propulsion system 200 gas turbine engine 201 may further comprise a booster 204 that is located axially forward from the compressor 205, as shown schematically in FIGS. 2 to 9. The booster 204 compresses an airflow entering it and supplies at least a portion of the compressed air that flows into the compressor 205. The booster may be driven by a low-pressure turbine 257. FIG. 6 shows schematically an embodiment of an intercooled propulsion system 200 having a gas turbine engine 201 comprising an embodiment of an intercooler 214. In an embodiment of the present invention shown in FIG. 6, the intercooler 214 is located axially forward from the booster 204 such that the intercooler 214 is capable of cooling at least a portion of an airflow 1 that flows in the booster 204. FIG. 6 shows schematically an intercooler 214 that comprises a direct heat exchanger 216. In the direct heat exchanger, heat transfer occurs directly through a metallic wall 241 between the cryogenic fuel 112 and at least a portion of the airflow through the booster. FIG. 7 shows schematically an embodiment of an intercooled propulsion system 200 having a gas turbine engine 201 comprising an embodiment of an intercooler 214. In an embodiment of the present invention shown in FIG. 7, the intercooler 214 is located axially forward from the booster 204 and comprises an indirect heat exchanger 217. As described previously, in the indirect heat exchanger 217, heat transfer occurs between a non-flammable working fluid 218 and at least a portion of the airflow 1 through the booster 204, and between the non-flammable working fluid 218 and the cryogenic fuel 112. Although the intercoolers 214 shown in FIGS. 6 and 7 are shown located axially forward from the booster, in other embodiments of the present invention, an intercooler 214 (direct type or indirect type) may be located near an intermediate stage of a multi stage booster 204 in a manner similar to that described above with respect to a multi stage compressor 205.

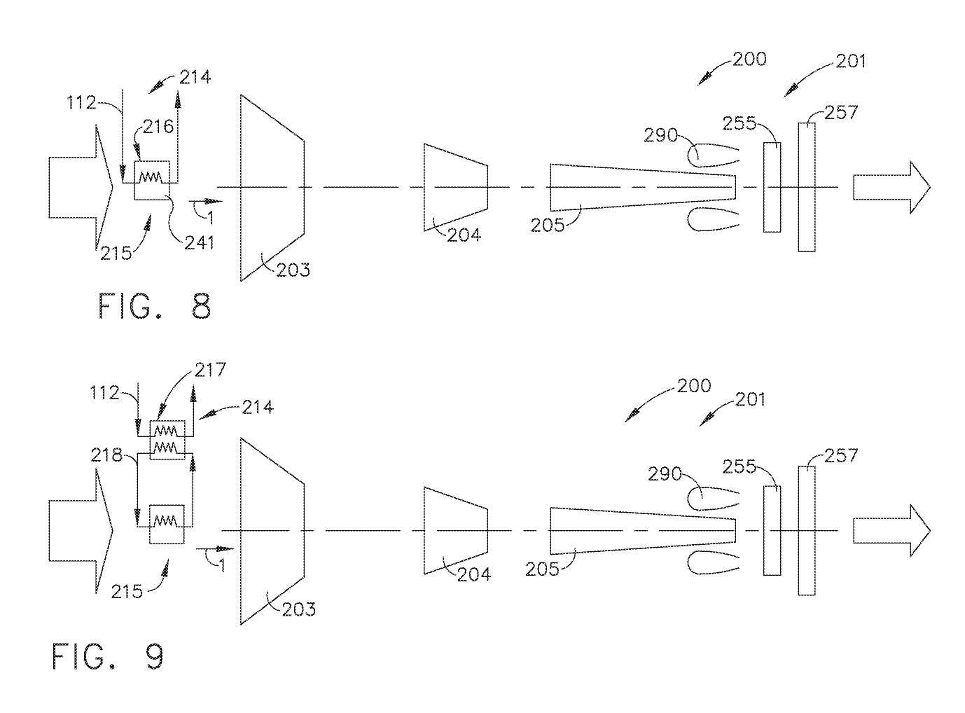

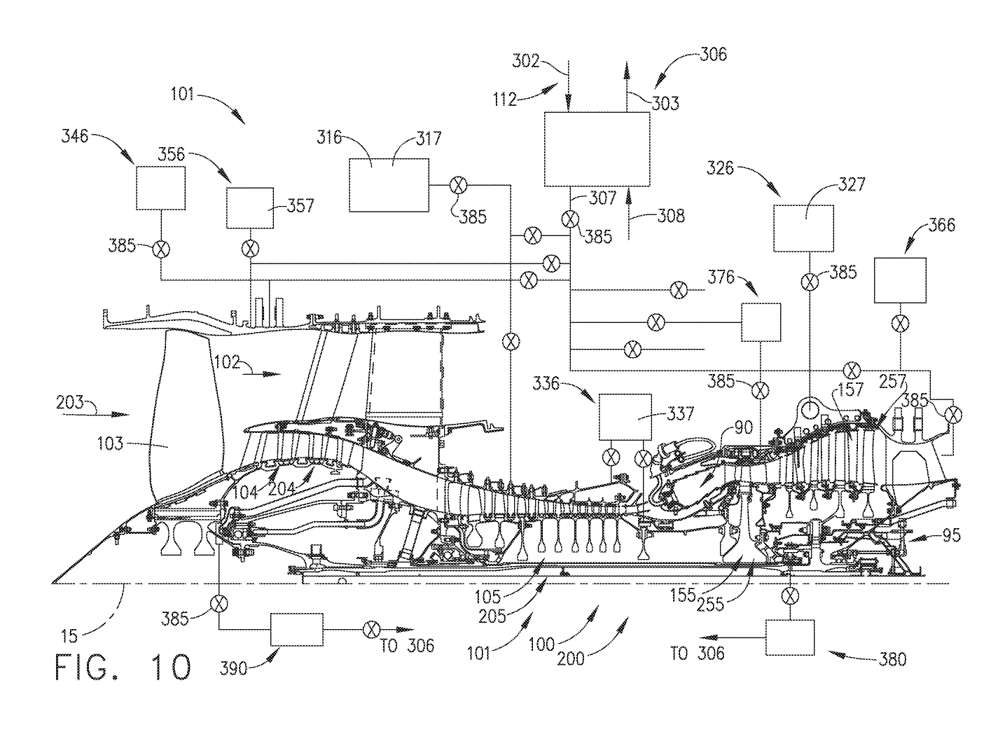

The propulsion system 200 gas turbine engine 201 may further comprise a fan 203 that is located axially forward from the compressor 205, as shown schematically in FIGS. 2 to 9. The fan 203 is driven by a low-pressure turbine 257 and at least a portion of the air entering the fan 203 enters the compressor 205. An intercooler 214 is located such that it is capable of cooling at least a portion of an airflow 1 that enters into the fan 203. In an embodiment of the present invention shown in FIG. 8, the intercooler 214 comprises a direct heat exchanger 216 wherein heat transfer occurs directly through a metallic wall 241 between the cryogenic fuel 112 and a portion of the airflow entering the fan 203. In an embodiment of the present invention shown in FIG. 9, the intercooler 214 comprises an indirect heat exchanger 217 wherein heat transfer occurs between a non-flammable working fluid 218 and a portion of the airflow entering the fan 203, and between the non-flammable working fluid 218 and the cryogenic liquid fuel 112. The direct heat exchanger and indirect heat exchanger are designed using known engineering methods and constructed using known materials.

In an embodiment of the present invention utilizing LNG as an aviation fuel, heat is required to change the fuel from liquid to gas form. As shown in the schematic block diagrams in FIGS. 2 to 9, heat exchangers can be utilized between the booster exit and the high pressure compressor inlet so that primary flowpath air will be cooled with minimal pressure loss. This cooled compressor inlet air allows for more heat addition either through increasing the overall pressure ratio of the compressor and/or through the addition of more fuel in the combustion process until operational temperature limits of the gas turbine are reached. These higher pressures and/or increased heat release rates in the combustor can provide increased efficiency and/or higher power within the engine cycle.

An intercooled aviation gas turbine engine architecture can be optimized using the advantages provided (lower specific fuel consumption or higher power) to reduce engine weight for a given application there by providing even more benefit in the form of operational costs and payload to the end user.

Other embodiments of the present invention of intercooled aviation gas turbine engines include intercooling a three spool aviation engine architecture where intercooling would be applied between the fan booster and intermediate compressor, between the intermediate compressor and the high-pressure compressor, and/or between both the spools. The intermediate compressor may be driven by an intermediate pressure turbine. An embodiment of the present invention would include multi-stage fan gas turbine engines where the portion of the fan stream directed toward the core flow would be intercooled.

As shown in FIGS. 8 and 9, an embodiment of the present invention incorporates intercooling at the engine inlet. Heat exchange between the gas turbine air stream and the natural gas fuel can be accomplished in a direct or indirect manner. As shown in FIGS. 6 and 7, an embodiment of the present incorporates intercooling between the fan and the booster. Heat exchange between the gas turbine air stream and the natural gas fuel can be accomplished in a direct or indirect manner. As shown in FIGS. 4 and 5, an embodiment of the present incorporates intercooling at an intermediate stage of the high pressure compressor. Heat exchange between the gas turbine air stream and the natural gas fuel can be accomplished in a direct or indirect manner.

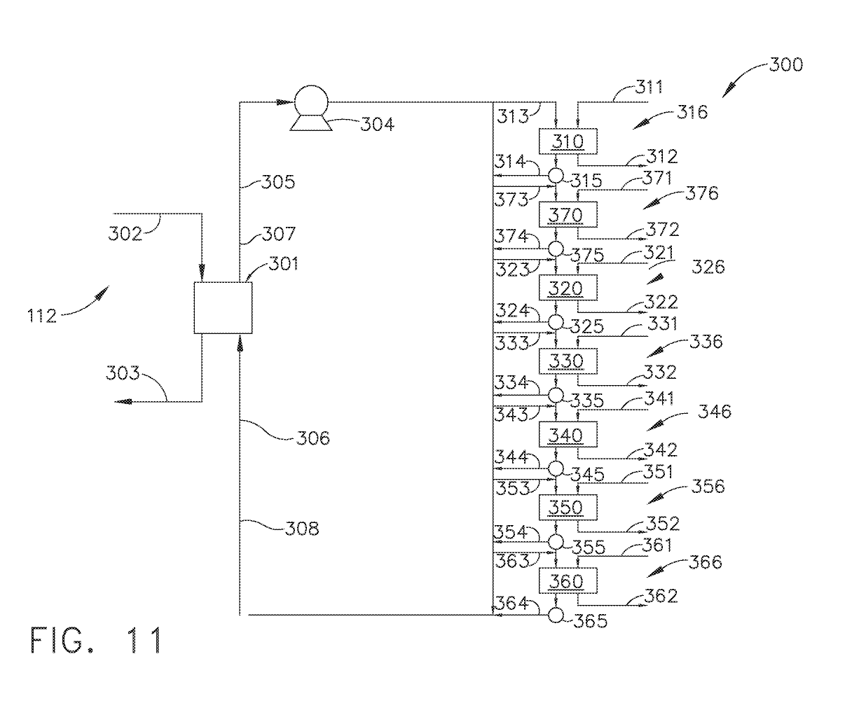

As shown schematically in FIGS. 10 to 20 and described below, the cryogenic fuel in a dual fuel propulsion system 100, 200 can be used for cooling other components and systems in the aircraft system 5 and/or the gas turbine engine 101. As described below in embodiments of the present invention, heat exchangers are used to utilize the heat sink capabilities of the cryogenic fuel, such as, for example, LNG, to cool gas turbine secondary parasitic flows, lubricating oils for engine bearing and gear systems, and related heat sources. Cooling these sub systems will result in more efficient engine systems 101 via reduced parasitic flows, which are losses to the engine performance cycle.

SECONDARY SYSTEMS HEAT EXCHANGERS: This class of heat exchanger is designed to utilize the heat sink capabilities of cryogenic fuels, such as, for example, LNG, to cool gas turbine secondary parasitic flows, lubricating oils for engine bearing and gear systems, and other heat sources. Cooling these sub systems will result in more efficient engine systems via reduced parasitic flows, which are losses to the engine performance cycle. These include:

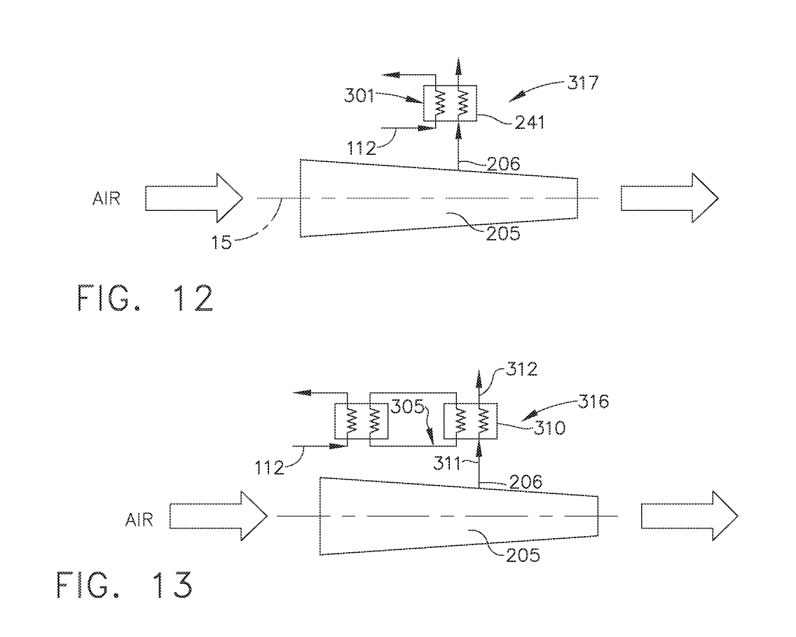

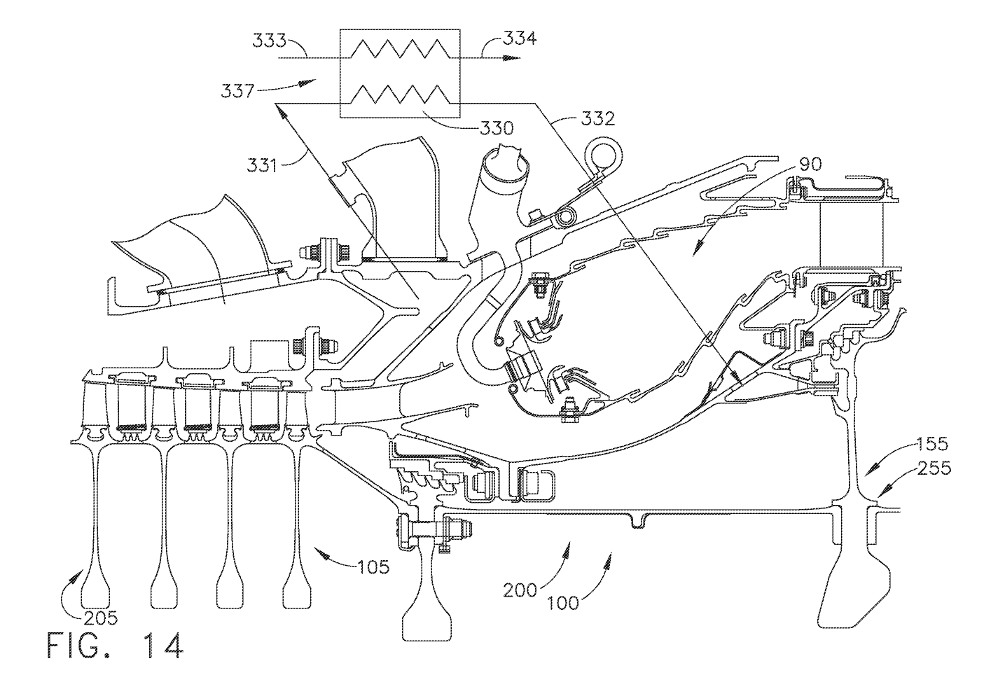

(A) A heat exchange system that utilizes LNG fuel to provide cooling to customer bleed air. Heat exchange can be accomplished in a direct or indirect manner. A schematic block diagram is provided in FIGS. 12 and 13.

(B) A heat exchange system that utilizes LNG fuel to provide cooling to turbine clearance control systems for added muscle. A schematic diagram is provided in FIG. 11.

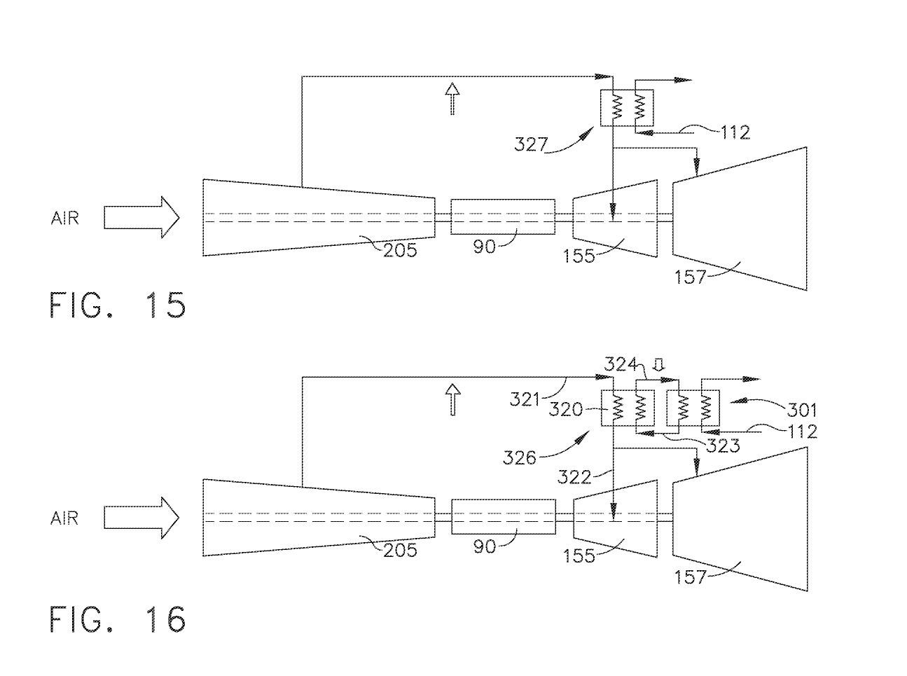

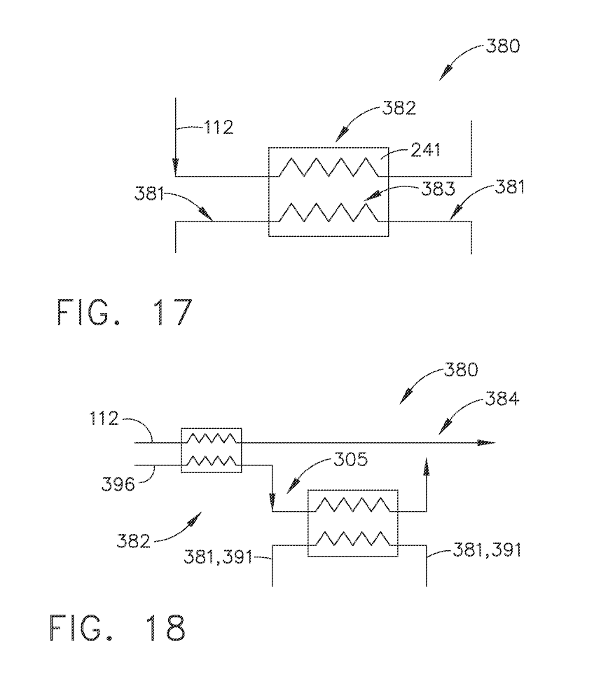

(C) A heat exchange system that utilizes LNG fuel to provide cooling to LPT pipes. Cooler LPT pipe flow results a need for less parasitic air flow, or improved cooling efficiency. A block diagram is shown in FIGS. 15 and 16.

(D) A heat exchange system that utilizes LNG fuel to provide cooling to HPT parasitic “cooled cooling” air used to cool HPT blades and or nozzles and or shrouds. A block diagram is provided in FIG. 14.

(E) A heat exchange system that utilizes LNG fuel to provide cooling to lube system oil which, in turn, is used to cool bearings and other oil wetted engine hardware. A block diagram is provided in FIGS. 17 and 18.

(F) A heat exchange system that utilizes LNG fuel to provide cooling to a geared turbofan system. A block diagram is provided in FIG. 19.

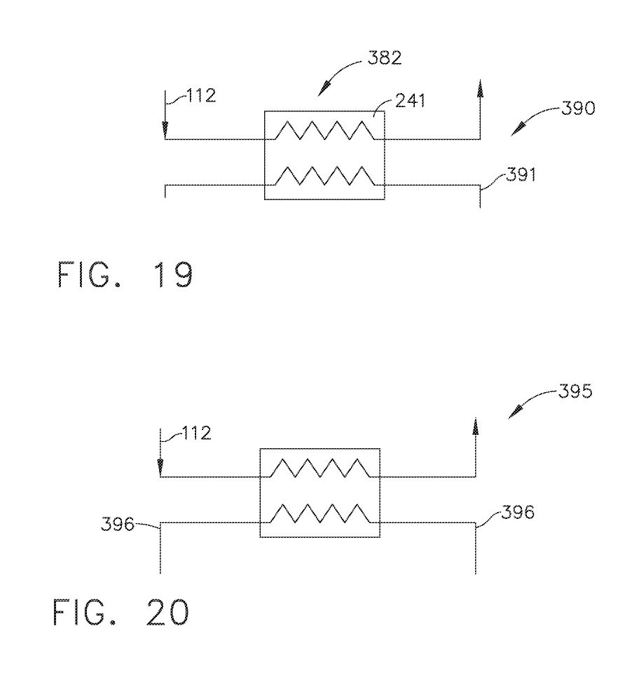

(G) A heat exchange system that utilizes LNG fuel to provide cooling to the engine core cowl. This, in turn, keeps critical controls system and other external hardware at acceptable operating temperatures. A block diagram is provided in FIG. 20.

(H) A heat exchange system that utilizes LNG fuel to provide cooling to Jet-A fuel, which, in turn, can then be used to cool any of the above systems. A block diagram is shown in FIG. 20.

As shown schematically in FIG. 11, an indirect cooling system 300—using an intermediate working fluid 305—can be fully integrated so that multiple heat exchangers can be utilized with a single working fluid 305 capable of cooling multiple parasitic and/or primary flows and/or electronics heat sources.

FIG. 10 shows schematically a dual fuel aviation gas turbine engine 101 comprising a compressor 105 driven by a turbine 155, a combustor 90 that generates hot gases that drive the turbine 155. Various optional heat exchangers are shown schematically in FIGS. 10-20 that utilize the cryogenic fuel 112 (such as LNG, for example) to cool one or more of the components and secondary systems of the engine, as described below. Any one, or a plurality, of these heat exchangers can be used in dual fuel gas turbine engine 101 for cooling components and systems. Various valves 385 may be included to open or close fluid communication with the various components and systems.

FIG. 11 shows schematically a cooling system 300 for a gas turbine engine propulsion system 200 comprising a heat exchanger 301, 316, 317 that uses a cryogenic liquid fuel 112, such as, for example, LNG, for cooling at least a portion of an airflow 206 extracted from the gas turbine engine propulsion system 200. The air flow 206 may be extracted from a compressor 205, such as, for example, shown in FIGS. 12, 13, and 14. In an embodiment of the present invention, the cryogenic liquid fuel 112 is Liquefied Natural Gas (LNG). The gas turbine engine further may comprise a fan 103 that generates a fan flow stream 102 wherein the airflow 206 to be cooled is extracted from the fan flow stream 102. In an embodiment of the present invention, the airflow 206 may be extracted from a booster 104 and cooled using the cryogenic fuel.

After being cooled by a cooling system, such as shown for example in FIGS. 10, 11, and 14, at least a portion of the airflow cooled by the heat exchanger 301, 330 is reintroduced into the gas turbine engine 101 for cooling at least a portion of a component in the engine 101. For example, a high-pressure turbine 155 can be cooled in this manner using a HPT cooler (heat exchanger), such as shown schematically in FIGS. 14 and 11. Similarly, a low-pressure turbine 157 may be cooled using an LPT cooler (heat exchanger) 320, 330, as shown schematically in FIGS. 15 and 16. Similarly, in an embodiment of the present invention, the component cooled is a portion of the combustor 90 (see FIG. 14).

In an embodiment of the present invention shown schematically in FIG. 12, the heat exchanger 317 comprises a direct heat exchanger 317 wherein heat transfer occurs directly through a metallic wall 241 between the cryogenic liquid fuel 112 and a portion of the airflow 206 extracted from the engine. An embodiment of the present invention of an HPT cooler 330 shown schematically in FIG. 14 also shows a direct heat exchanger 337. The hot air flow 331 is cooled to a cooler air flow 332 by the direct heat exchanger. The cryogenic fuel inflow 333 absorbs heat from the airflow 331 and exits as out flow 334.

In an embodiment of the present invention shown schematically in FIG. 13, the compressor air cooling system comprises an indirect heat exchanger 316 wherein heat transfer occurs between a working fluid 305 and a portion 311 of the airflow 206, and between the working fluid 305 and the cryogenic fuel 112. The working fluid 305 is non-flammable. In an embodiment of the present invention, the working fluid 305 is a liquid fuel (such as, for example, first fuel 11), and is capable of being ignited in the gas turbine engine propulsion system 100.

FIG. 11 shows schematically a cooling system 300 for a dual fuel aircraft gas turbine engine propulsion system 100, 200. It comprises a heat exchanger 301 that uses a cryogenic fuel 112, such as, for example, LNG, to cool an intermediary working fluid 305 that circulates in a working fluid circuit 306. The working fluid circuit comprises a pump 304 that circulates the working fluid. The working fluid circuit 306 is constructed using suitable known materials having thermal insulating properties to prevent unwanted heating of the working fluid by the environment. The working fluid 305 is then circulated through one or more heat exchangers, such as, for example shown schematically in FIG. 11 as items 310, 320, 330, 340, 350, 360, and 370. The flow of the cooler working fluid 305 in each heat exchanger 310, 320, 330, 340, 350, 360, and 370 is controlled by a control valve 315, 325, 335, 345, 355, 365, and 375, respectively. Flow into each heat exchanger is via inlets 313, 323, 333, 343, 353, 363, and 373 and outlets 314, 324, 334, 344, 354, 364, and 374, respectively. Each of the heat exchangers supplies cooled fluid or gas via outlets 312, 322, 332, 342, 352, 362, and 372 which is returned via inlets 311, 321, 331, 341, 351, 361, and 371, respectively. All of these various inlets, outlets, valves, heat exchangers, and components are shown schematically in FIG. 11.

In an embodiment of the present invention, the heat exchanger 310 is a compressor air cooler for cooling a portion of a component 316 associated with the gas turbine engine propulsion system 100, 200. In an embodiment of the present invention, the heat exchanger 330, 320 is a turbine cooling air heat exchanger for cooling a portion of an HPT/LPT (336, 326, respectively) associated with the gas turbine engine propulsion system 100, 200. For example, see FIGS. 14, 15 and 16. Where sufficient heat is transferred to the LNG 112, it may exit the heat exchanger as gaseous NG. In an embodiment of the present invention, the heat exchanger 340 is an electronic system cooler for cooling a portion of an electronic system 346 associated with the aircraft system 5, such as, for example, an avionics system. In an embodiment of the present invention, the heat exchanger 350 is a control system cooler for cooling a portion of a control system 357, such as a Full Authority Digital Electronic Control (FADEC) 357 associated with the gas turbine engine propulsion system 100, 200. In an embodiment of the present invention, the heat exchanger 360 is an exhaust gas cooler 366 for cooling a portion of the exhaust gas from the gas turbine engine exhaust system 95. FIG. 11 shows hot gas or fluid entering each respective heat exchanger and leaving it after being cooled by the working fluid 305. The operation of the cooling circuit for each sub-system can be controlled by their respective control valves 315, 325, 335, 345, 355, 365, and 375.

In an embodiment of the present invention, a cooling system 380 for a gas turbine engine propulsion system 101 is disclosed, comprising a heat exchanger 382 that uses a cryogenic liquid fuel 112 for cooling at least a portion of a lubricating oil 381, 391 used in the gas turbine engine propulsion system 101. Lubricating oils in gas turbine engines get hot and it is advantageous to cool the lubricating oils in bearings, gears, etc. so that their operating life can be extended. In an embodiment of the present invention, the cryogenic liquid fuel 112 used for cooling the lubricating oils is Liquefied Natural Gas (LNG). FIGS. 17 and 18 show schematically heat exchanger systems 382, 384 for cooling lubricating oil 381 using cryogenic fuel 112 such as, for example, LNG. FIG. 17 shows a direct heat exchanger 383 wherein heat transfer occurs directly through a metallic wall 241 between the cryogenic liquid fuel 112 and a portion of the lubricating oil 381. FIG. 19 shows an embodiment of a direct heat exchanger 382 in a gear oil cooler 390 in a geared turbo fan engine. In an embodiment of the present invention, heat transfer in the gear oil cooler 390 occurs directly through a metallic wall 241 between the cryogenic liquid fuel 112 and a portion of the oil 391.

FIG. 18 shows a lubricating oil cooling system 380 with a heat exchanger 382 comprising an indirect heat exchanger 384 wherein heat transfer occurs between a working fluid 305 and the cryogenic liquid fuel 112 and between the working fluid 305 and a portion of the lubricating oil 381 or gear oil 391. In embodiments of the present invention shown herein, the working fluid 305 used is non-flammable when used in hot section components such as the combustor or turbine. In an embodiment of the present invention, the cooling system shown in FIGS. 10 and 11 may use a liquid fuel 396 as the working fluid 305 wherein the liquid fuel 396 may be ignited in the combustor of the gas turbine engine propulsion system 101. Such a system may be useful for cooling electronic systems including avionics and FADEC 357. A heat exchange system that utilizes cryogenic fuel may be used to provide cooling to the engine core cowl. This, in turn, keeps critical controls system and other external hardware at acceptable operating temperatures. A schematic block diagram of a system is provided in FIG. 19. A heat exchange system that utilizes cryogenic fuel may be used to provide cooling to Jet-A fuel, which, in turn, can then be used to cool any of the systems previously herein. A schematic block diagram of a system including a heat exchanger 395 is provided in FIG. 20.

Some of the various cooling systems described herein are shown schematically with respect to a dual fuel propulsion system 100, 200 in FIG. 10. Flow in such systems may be co-flow or counter flow, dependent upon the temperatures, flow rates, and other operational conditions present in each system.

An exhaust system cooling system 366 is shown schematically in FIGS. 10 and 11.

In an embodiment of the present invention, an exhaust system cooling system consists of a heat exchanger in thermal contact with the aircraft gas turbine exhaust system acting as a heat source, and cryogenic fuel (such as, for example, liquefied natural gas (LNG)), as a heat sink. The heat exchanger can be separate or integral with the aircraft gas turbine exhaust nozzle. Alternatively, it can be mounted to the engine turbine frame, nacelle, core cowl, or other structure. Cryogenic fuel (for example, LNG) is passed through the heat exchanger by use of a cryogenic pump.

In an embodiment of the present invention, the heat exchanger may be mounted flush to the exhaust nozzle, with limited protrusions in the flowpath, so as to minimize aerodynamic losses in the exhaust stream. The design of the heat exchanger may conform to the curvature of the exhaust nozzle.

In an embodiment of the present invention, the heat exchanger comprises a heat exchanger in thermal contact with the aircraft gas turbine exhaust system acting as a heat source, and a non-combustible, “indirect” working fluid—such as Dowtherm—as the heat sink. A second heat exchanger in which liquefied natural gas and Dowtherm are in thermal contact completes the transfer of waste heat from the exhaust, to the cold, liquefied natural gas (LNG) fuel. The two heat exchangers described above can consist of two separate units, or one single unit mounted to the engine, nacelle, or exhaust system.

In an embodiment of the present invention, the heat exchanger comprises a heat exchanger in thermal contact with the aircraft gas turbine exhaust system acting as a heat source, and a non-combustible working fluid—such as Dowtherm—as the heat sink. A second heat exchanger in which liquefied natural gas and Dowtherm are in thermal contact completes the transfer of waste heat from the exhaust, to the cold, liquefied natural gas (LNG) fuel. Under circumstances when little or no LNG is flowing to the engine fuel delivery system, the working fluid can be re-directed to a heat exchange element in thermal contact with the aircraft gas turbine fan bypass stream.

The exhaust system heat exchanger can be of various designs, including shell and tube, double pipe, fin plate, etc., and can flow in a co-current, counter current, or cross current manner. A heat exchange can occur in direct or indirect contact with the heat sources listed above.

As shown schematically in FIGS. 21 to 22 and 11, and described below, the cryogenic fuel in a dual fuel propulsion system 100, 200 can be used for cooling certain components in a dual fuel aircraft gas turbine engine 101, 201. As described herein, heat exchangers are used to utilize the heat sink capabilities of the cryogenic fuel, such as, for example, LNG, to cool a portion of air extracted from the gas turbine, such as, for example from a compressor 105. A portion of the cooled cooling air can be used for turbine or compressor clearance control. Controlling the clearances in a turbine or compressor during engine operation is known to result in more efficient engine systems 101, and improved engine performance cycle and lower specific fuel consumption.

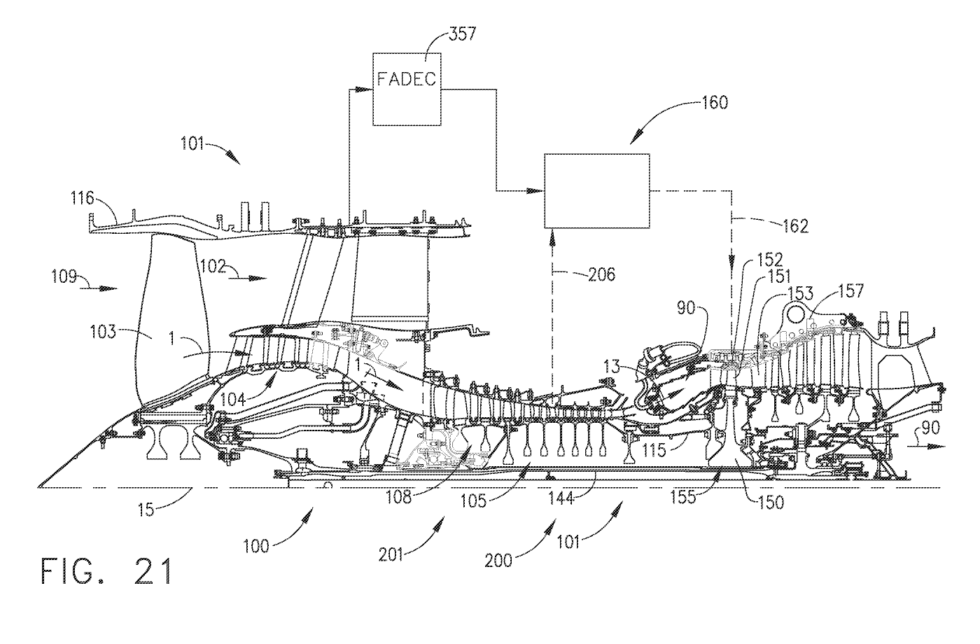

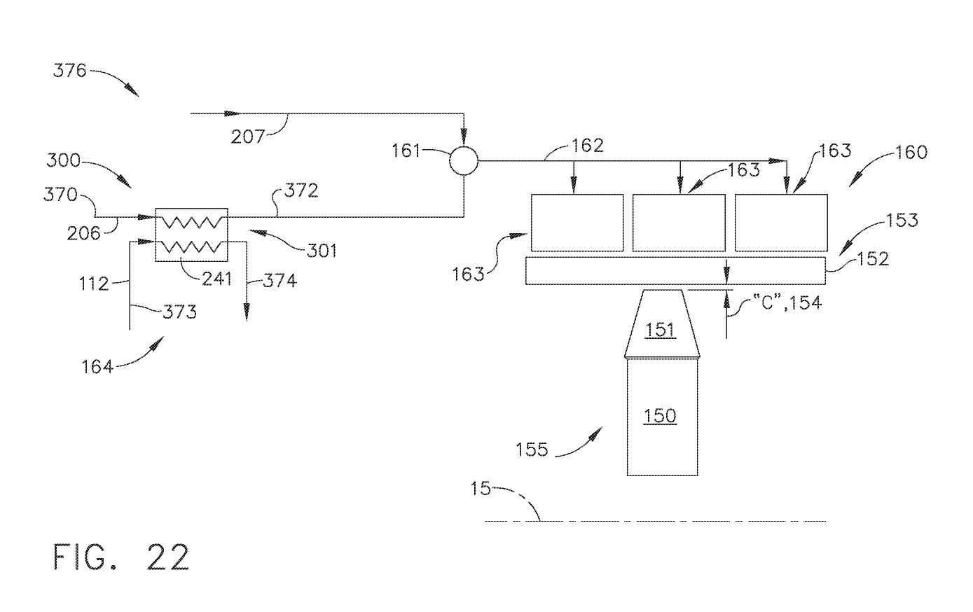

FIG. 21 shows a dual fuel aviation gas turbine engine system 101, 201 comprising a turbine clearance control (“TCC”) system 160 that uses a cryogenic fuel, such as, for example, LNG. FIG. 22 shows the schematically the heat exchanger 301, 164 and turbine structures 163, 152, 153, 151, 150. Some of these turbine structures 163 are cooled and/or heated by the TCC system 160 during engine operation. The dual fuel aviation gas turbine engine system 101, 201 comprises a compressor 105 driven by a turbine 155. The turbine has a rotor 150 having a circumferential row of turbine blades 151, and a shroud 152 located radially outward from the turbine blades such that there is a radial clearance “C” between the blades and the shroud. Stator blades 153 are located downstream of the turbine blades 151. The turbine 155 is driven by hot gases generated in a combustor 90. A turbine clearance control system 160 comprises a cooling system 300 having a heat exchanger 301 that uses a cryogenic liquid fuel 112 for cooling at least a portion of an airflow 206 that is used for controlling the radial clearance “C” 154 during operation of the gas turbine engine propulsion system 101. The radial clearance “C” can be reduced, for example, by cooling the static structures 163 that surround the rotor blades 151 thereby radially shrinking the static structures due to thermal effects. This can be accomplished by directing relatively cooler air 162 from the TCC system 160 towards the static structures 163. Similarly, the radial clearance “C” can be increased, for example, by heating the static structures 163 using hot air from the TCC system 160. FIG. 22 shows schematically a heat exchanger 301 that uses a the cryogenic fuel 112 such as, for example, Liquefied Natural Gas (LNG), for cooling a portion of hot air 206 extracted from the compressor 105 of a gas turbine engine 101. In embodiments of the present invention, the airflow 206 may extracted from a fan flow stream 102 (or a booster 104) of the gas turbine engine.

In FIG. 22, a heat exchanger 301 comprises a direct heat exchanger 164 wherein heat transfer occurs directly through a metallic wall 241 between the cryogenic liquid fuel 112 and a portion of the airflow 206. In embodiments of the present invention, the heat exchanger 301 may comprise an indirect heat exchanger 370 wherein heat transfer occurs between a working fluid 305 and a portion of the airflow 206, and between the working fluid 305 and the cryogenic fuel 112. In an embodiment of the present invention, the working fluid 305 is non-flammable. In some applications, the working fluid 305 may a liquid fuel, such as the first fuel 11, that can be ignited in the combustor 90.

FIG. 21 shows an embodiment of a gas turbine engine 101 having a turbine clearance control system 160 wherein at least a portion of the airflow 372 cooled by the heat exchanger 301 of the turbine clearance control system 160 is reintroduced into the gas turbine engine for cooling at least a portion of a static structure 163 near a turbine 155. The static structure 163 may support the shroud 152 that is located radially out from the turbine blades 151 such that there is a radial clearance “C” between the blade 151 and the shroud 152. The turbine may be a high-pressure turbine 155 or a low-pressure turbine 157. As shown in FIG. 22, the TCC system 160 may further comprise a turbine clearance control valve 161 that regulates the temperature and amount of the turbine clearance control air 162 by mixing a cooler air 372 with a hotter air 207. The clearance control valve 161 may be regulated by a digital electronic control system 357, such as a FADEC system shown schematically in FIG. 21.

This written description uses examples to disclose the invention, including the best mode, and also to enable any person skilled in the art to make and use the invention. The patentable scope of the invention may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A gas turbine engine propulsion system comprising:
a system that uses a cryogenic liquid fuel for a non-combustion function.

2. The gas turbine engine propulsion system according to claim 1, wherein the cryogenic liquid fuel is Liquefied Natural Gas (LNG).

3. The gas turbine engine propulsion system according to claim 1, wherein the non-combustion function is a cooling function.

4. An intercooled gas turbine engine comprising:
a compressor driven by a turbine;
a combustor configured to generate hot gases, wherein the hot gases drive the turbine; and
an intercooler comprising a heat exchanger, wherein the heat exchanger uses a cryogenic liquid fuel for cooling at least a portion of an airflow that flows into the compressor.

5. The intercooled gas turbine engine according to claim 4, wherein the cryogenic liquid fuel is Liquefied Natural Gas (LNG).

6. The intercooled gas turbine engine according to claim 4, wherein the intercooler further comprises a direct heat exchanger, wherein a heat transfer occurs directly through a metallic wall between the cryogenic liquid fuel and at least a portion of the airflow.

7. The intercooled gas turbine engine according to claim 4, wherein the intercooler further comprises an indirect heat exchanger, wherein a heat transfer occurs between a non-flammable working fluid and at least a portion of the airflow, and between the non-flammable working fluid and the cryogenic liquid fuel.

8. The intercooled gas turbine engine according to claim 4, wherein the intercooler is located near an intermediate stage of the compressor such that at least a portion of the airflow through the compressor is cooled.

9. The intercooled gas turbine engine according to claim 8, wherein the intercooler further comprises a direct heat exchanger wherein a heat transfer occurs directly through a metallic wall between the cryogenic liquid fuel and at least a portion of the airflow through the compressor.

10. The intercooled gas turbine engine according to claim 8, wherein the intercooler further comprises an indirect heat exchanger wherein a heat transfer occurs between a non-flammable working fluid and at least a portion of the airflow through the compressor, and between the non-flammable working fluid and the cryogenic liquid fuel.

11. The intercooled gas turbine engine according to claim 4, further comprising:
a booster located axially forward from the compressor wherein the booster is driven by a low-pressure turbine, and wherein the booster supplies at least a portion of the airflow that flows into the compressor.

12. The intercooled gas turbine engine according to claim 11, wherein the intercooler is located such that the intercooler is configured to cool at least a portion of an airflow that flows into the booster.

13. The intercooled gas turbine engine according to claim 12, wherein the intercooler comprises a direct heat exchanger wherein heat transfer occurs directly through a metallic wall between the cryogenic liquid fuel and at least a portion of the airflow through the compressor.

14. The intercooled gas turbine engine according to claim 12, wherein the intercooler comprises an indirect heat exchanger wherein a heat transfer occurs between a non-flammable working fluid and at least a portion of the airflow through the compressor, and between the non-flammable working fluid and the cryogenic liquid fuel.

15. The intercooled gas turbine engine according to claim 4, further comprising:
a fan located axially forward from the compressor wherein the fan is driven by a low-pressure turbine, and wherein at least a portion of the air entering the fan enters the compressor.

16. The intercooled gas turbine engine according to claim 15, wherein the intercooler is located such that the intercooler is configured to cool at least a portion of an airflow that enters into the fan.

17. The intercooled gas turbine engine according to claim 16, wherein the intercooler comprises a direct heat exchanger wherein a heat transfer occurs directly through a metallic wall between the cryogenic liquid fuel and at least a portion of the airflow entering the fan.

18. The intercooled gas turbine engine according to claim 16, wherein the intercooler comprises an indirect heat exchanger wherein a heat transfer occurs between a non-flammable working fluid and at least a portion of the airflow entering the fan, and between the non-flammable working fluid and the cryogenic liquid fuel.

19. A cooling system for a gas turbine engine propulsion system, the cooling system comprising:
a heat exchanger that uses a cryogenic liquid fuel for cooling at least a portion of an airflow extracted from the gas turbine engine propulsion system.

20. The cooling system according to claim 19, wherein the cryogenic liquid fuel is Liquefied Natural Gas (LNG).

21. The cooling system according to claim 19, wherein the heat exchanger comprises a direct heat exchanger wherein a heat transfer occurs directly through a metallic wall between the cryogenic liquid fuel and at least a portion of the airflow.

22. The cooling system according to claim 19, wherein the heat exchanger comprises an indirect heat exchanger wherein a heat transfer occurs between a working fluid and at least a portion of the airflow, and between the working fluid and the cryogenic liquid fuel.

23. The cooling system according to claim 22, wherein the working fluid is non-flammable.

24. The cooling system according to claim 22, wherein the working fluid is a liquid fuel capable of being configured to be ignited in the gas turbine engine propulsion system.

25. The cooling system according to claim 19, wherein the airflow is extracted from a compressor.

26. The cooling system according to claim 19, wherein the airflow is extracted from a fan.

27. The cooling system according to claim 19, wherein the airflow is extracted from a booster.

28. The cooling system according to claim 19, wherein at least a portion of the airflow cooled by the heat exchanger is reintroduced into the gas turbine engine propulsion system for cooling at least a portion of a component.

29. A gas turbine engine comprising:
a compressor driven by a turbine;
a combustor that generates hot gases that drive the turbine; and
a cooling system comprising a heat exchanger that uses a cryogenic liquid fuel for cooling at least a portion of an airflow extracted from the gas turbine engine.

30. The gas turbine engine according to claim 29, wherein the cryogenic liquid fuel is Liquefied Natural Gas (LNG).

31. The gas turbine engine according to claim 29, wherein the heat exchanger comprises a direct heat exchanger wherein a heat transfer occurs directly through a metallic wall between the cryogenic liquid fuel and at least a portion of the airflow.

32. The gas turbine engine according to claim 29, wherein the heat exchanger comprises an indirect heat exchanger wherein a heat transfer occurs between a working fluid and at least a portion of the airflow, and between the working fluid and the cryogenic liquid fuel.

33. The gas turbine engine according to claim 32, wherein the working fluid is non-flammable.

34. The gas turbine engine according to claim 32, wherein the working fluid is a liquid fuel configured to be ignited in the combustor.

35. The gas turbine engine according to claim 29, wherein the airflow is extracted from the compressor.

36. The gas turbine engine according to claim 29, further comprising a fan that generates a fan flow stream wherein the airflow is extracted from the fan flow stream.

37. The gas turbine engine according to claim 29, wherein at least a portion of the airflow cooled by the heat exchanger is reintroduced into the gas turbine engine for cooling at least a portion of a component.

38. The gas turbine engine according to claim 37, wherein the component is a high-pressure turbine.

39. The gas turbine engine according to claim 37, wherein the component is a low-pressure turbine.

40. The gas turbine engine according to claim 37, wherein the component is the combustor.

41. A cooling system for a gas turbine engine propulsion system, the cooling system comprising:
a heat exchanger that uses a cryogenic liquid fuel for cooling at least a portion of a working fluid, that cools at least a portion of a component associated with the gas turbine engine propulsion system.

42. The cooling system according to claim 41, wherein the cryogenic liquid fuel is Liquefied Natural Gas (LNG).

43. The cooling system according to claim 41, wherein the component is a portion of a digital electronic control system.

44. The cooling system according to claim 41, wherein the component is a portion of an avionics system.

45. The cooling system according to claim 41, wherein the component is a portion of an exhaust system.

46. A cooling system for a gas turbine engine propulsion system, the cooling system comprising:
a heat exchanger that uses a cryogenic liquid fuel for cooling at least a portion of a lubricating oil used in the gas turbine engine propulsion system.

47. The cooling system according to claim 46, wherein the cryogenic liquid fuel is Liquefied Natural Gas (LNG).

48. The cooling system according to claim 46, wherein the lubricating oil is a bearing lubricating oil.

49. The cooling system according to claim 46, wherein the lubricating oil is a gear oil.

50. The cooling system according to claim 46, wherein the heat exchanger comprises a direct heat exchanger wherein a heat transfer occurs directly through a metallic wall between the cryogenic liquid fuel and at least a portion of the lubricating oil.

51. The cooling system according to claim 46, wherein the heat exchanger comprises an indirect heat exchanger wherein a heat transfer occurs between a working fluid and the cryogenic liquid fuel, and between the working fluid and at least a portion of the lubricating oil.

52. The cooling system according to claim 51, wherein the working fluid is non-flammable.

53. The cooling system according to claim 51, wherein the working fluid is a liquid fuel configured to be ignited in the gas turbine engine propulsion system.

54. A gas turbine engine propulsion system comprising:
a compressor driven by a turbine, the turbine comprising a rotor comprising a circumferential row of turbine blades, and a shroud located radially outward from the turbine blades such that there is a radial clearance between the turbine blades and the shroud;
a combustor that generates hot gases that drive the turbine; and
a rotor clearance control system comprising a cooling system comprising a heat exchanger that uses a cryogenic liquid fuel for cooling at least a portion of an airflow that is used for controlling the radial clearance during operation of the gas turbine engine propulsion system.

55. The gas turbine engine propulsion system according to claim 54, wherein the cryogenic liquid fuel is Liquefied Natural Gas (LNG).

56. The gas turbine engine propulsion system according to claim 54, wherein the heat exchanger comprises a direct heat exchanger wherein a heat transfer occurs directly through a metallic wall between the cryogenic liquid fuel and at least a portion of the airflow.

57. The gas turbine engine propulsion system according to claim 54, wherein the heat exchanger comprises an indirect heat exchanger wherein a heat transfer occurs between a working fluid and at least a portion of the airflow, and between the working fluid and the cryogenic liquid fuel.

58. The gas turbine engine propulsion system according to claim 57, wherein the working fluid is non-flammable.

59. The gas turbine engine propulsion system according to claim 57, wherein the working fluid is a liquid fuel capable of being configured to be ignited in the combustor.

60. The gas turbine engine propulsion system according to claim 54, wherein the airflow is extracted from the compressor.

61. The gas turbine engine propulsion system according to claim 54, further comprising a fan that generates a fan flow stream wherein the airflow is extracted from the fan flow stream.

62. The gas turbine engine propulsion system according to claim 54, wherein at least a portion of the airflow cooled by the heat exchanger is reintroduced into the gas turbine engine propulsion system for cooling at least a portion of a static structure that supports the shroud.

63. The gas turbine engine propulsion system according to claim 54, wherein the turbine is a high-pressure turbine.

64. The gas turbine engine propulsion system according to claim 54, wherein the turbine is a low-pressure turbine.

65. The gas turbine engine propulsion system according to claim 54, further comprising a turbine clearance control valve that regulates the turbine clearance control air.

66. The gas turbine engine propulsion system according to claim 65, wherein the clearance control valve is regulated by a digital electronic control system.
